(19) United States
(12) Patent Application Publication
(10) Pub. No.: US 2025/0389893 A1
(43) Pub. Date: Dec. 25, 2025

(54) METHOD OF MANUFACTURING OPTICAL WAVEGUIDE ELEMENT

(71) Applicant: TDK CORPORATION, Tokyo (JP)

(72) Inventors: Hiroki HARA, Tokyo (JP); Jiro YOSHINARI, Tokyo (JP); Shigeru MIEDA, Tokyo (JP); Kenji SASAKI, Tokyo (JP)

(73) Assignee: TDK CORPORATION, Tokyo (JP)

(21) Appl. No.: 19/239,025

(22) Filed: Jun. 16, 2025

(30) Foreign Application Priority Data
Jun. 24, 2024 (JP) 2024-101110

(51) Int. Cl. G02B 6/136; G02B 6/12; G02F 1/035

(52) U.S. Cl. CPC G02B 6/136; G02F 1/035; G02B 2006/1204; G02B 2006/12045; G02B 2006/12097; G02B 2006/12169

(57) ABSTRACT

A method of manufacturing an optical waveguide element includes: a step of preparing a structure including a substrate and a ridge-shaped optical waveguide layer provided on the substrate and made of a crystal material having an electro-optic effect; a step of depositing all of a cladding layer covering the optical waveguide layer; and a step of performing a heat treatment on the structure on which the cladding layer has been deposited.

### CROSS-REFERENCE TO RELATED APPLICATION

This application claims the benefit of priority from Japanese Patent Application No. 2024-101110 filed with the Japan Patent Office on Jun. 24, 2024, the entire contents of which are incorporated herein by reference.

### TECHNICAL FIELD

The present disclosure relates to a method of manufacturing an optical waveguide element.

### BACKGROUND

An optical waveguide element including a substrate, an optical waveguide layer provided on the substrate and made of a crystal material having an electro-optic effect such as a lithium niobate film, and a cladding layer provided so as to cover the optical waveguide layer is known. As a method of manufacturing such an optical waveguide element, for example, Japanese Patent No. 6136666 discloses that a ridge is formed by etching a lithium niobate film formed on a substrate, and a low-loss optical waveguide is obtained by performing a heat treatment.

### SUMMARY

When the cladding layer is formed on the optical waveguide layer, an oxygen defect, in which oxygen drops out from the crystal structure of the crystal material, may occur on the surface of the optical waveguide layer. In this case, there is a possibility that the propagation loss of the manufactured optical waveguide element becomes large.

The present disclosure describes a method of manufacturing an optical waveguide element capable of manufacturing an optical waveguide element with a low propagation loss.

A method of manufacturing an optical waveguide element according to one aspect of the present disclosure includes: a step of preparing a structure including a substrate and a ridge-shaped optical waveguide layer provided on the substrate and made of a crystal material having an electro-optic effect; a step of depositing all of a cladding layer covering the optical waveguide layer; and a step of performing a heat treatment on the structure on which the cladding layer has been deposited.

In the method of manufacturing an optical waveguide element, the heat treatment is performed after the cladding layer covering the optical waveguide layer is deposited. Therefore, even if an oxygen defect occurs on the surface of the optical waveguide layer when the cladding layer is deposited, oxygen is supplied to the optical waveguide layer through the cladding layer by the heat treatment. As a result, since the oxygen defect is compensated, the propagation loss of the optical waveguide element can be reduced. As described above, the method of manufacturing an optical waveguide element makes it possible to manufacture the optical waveguide element with a low propagation loss.

A temperature of the above-described heat treatment may be 400° C. or more and 700° C. or less. In this case, the time required for the heat treatment can be shortened while reducing the possibility of cracks occurring in the optical waveguide layer.

A method of manufacturing an optical waveguide element according to another aspect of the present disclosure includes: a step of preparing a structure including a substrate and a ridge-shaped optical waveguide layer provided on the substrate and made of a crystal material having an electro-optic effect; a step of depositing a partial portion of a cladding layer covering the optical waveguide layer; a step of performing a heat treatment on the structure on which the partial portion of the cladding layer is deposited; and a step of depositing a remaining portion of the cladding layer so as to cover the partial portion of the cladding layer after the heat treatment.

In the method of manufacturing an optical waveguide element, the cladding layer covering the optical waveguide layer is formed in two stages of the partial portion and the remaining portion, and after the partial portion of the cladding layer is deposited, the heat treatment is performed. Therefore, even if oxygen defects occur on the surface of the optical waveguide layer when the partial portion of the cladding layer is deposited, oxygen is supplied to the optical waveguide layer through the partial portion of the cladding layer by the heat treatment. As a result, since the oxygen defect is compensated, the propagation loss of the optical waveguide element can be reduced. Since the heat treatment is performed after the partial portion of the cladding layer has been deposited, oxygen is more likely to pass through the partial portion of the cladding layer than when the heat treatment is performed after all of the cladding layer has been deposited. That is, since oxygen is efficiently supplied to the optical waveguide layer, the time required for the heat treatment can be shortened. As described above, the method of manufacturing an optical waveguide element makes it possible to manufacture the optical waveguide element with a low propagation loss while improving the manufacturing efficiency.

A film thickness of the partial portion of the cladding layer may be smaller than a film thickness of the remaining portion of the cladding layer. In this case, oxygen is more likely to pass through the partial portion of the cladding layer. In other words, oxygen is supplied to the optical waveguide layer more efficiently. Therefore, the manufacturing efficiency of the optical waveguide element with a low propagation loss can be further improved.

A film thickness of the partial portion of the cladding layer may be 10 nm or more and 100 nm or less. In this case, while the partial portion of the cladding layer can be deposited with a uniform film thickness, the rate (transmittance) at which oxygen passes through the partial portion of the cladding layer can be increased.

A temperature of the heat treatment performed on the structure on which the partial portion of the cladding layer is deposited may be 400° C. or more and 700° C. or less. In this case, the time required for the heat treatment can be shortened while reducing the possibility of cracks occurring in the optical waveguide layer.

The method of manufacturing an optical waveguide element may further include a step of performing a heat treatment on the structure on which the cladding layer has been deposited by depositing the remaining portion of the cladding layer. In this case, the heat treatment is performed after the cladding layer has been deposited. Therefore, even if an oxygen defect occurs on the surface of the optical waveguide layer when the remaining portion of the cladding layer is deposited, oxygen is supplied to the optical waveguide layer through the cladding layer by the heat treatment. As a result, since the oxygen defect is compensated, the propagation loss of the optical waveguide element can be further reduced. Therefore, it is possible to manufacture the optical waveguide element with a further lower propagation loss.

A temperature of the heat treatment performed on the structure on which the cladding layer has been deposited may be 550° C. or more and 650° C. or less. In this case, the possibility of cracks occurring in the optical waveguide layer can be reduced, and the time required for the heat treatment can be shortened.

The step of preparing the structure may include: a step of forming a crystal film made of the crystal material on the substrate; a step of forming the optical waveguide layer by etching the crystal film; and a step of performing a heat treatment on the optical waveguide layer. In this case, the heat treatment is performed after the optical waveguide layer is formed. Therefore, even if an oxygen defect occurs on the surface of the optical waveguide layer by etching, oxygen is supplied to the optical waveguide layer by the heat treatment. As a result, since the oxygen defect is compensated, the propagation loss of the optical waveguide element can be further reduced. Therefore, it is possible to manufacture the optical waveguide element with a further lower propagation loss.

The crystal material may be lithium niobate or lithium tantalate. By using these crystal materials, an excellent electro-optic effect can be obtained.

The optical waveguide layer may have c-axis orientation. In this case, an electric field is applied to the ridge-shaped optical waveguide in the direction in which the optical waveguide layer is laminated on the substrate. Therefore, the degree of freedom in designing the optical waveguide layer can be improved, for example, by allowing the optical waveguide to be curved.

The cladding layer may be made of silicon oxide. Since silicon oxide has a relatively low refractive index, the possibility that light is confined in the optical waveguide layer can be increased. Therefore, the propagation loss of the optical waveguide element can be further reduced.

The method of manufacturing an optical waveguide element may further include: a step of planarizing the cladding layer; a step of performing a heat treatment on the structure after the cladding layer is planarized; a step of depositing a buffer layer on the planarized cladding layer; a step of performing a heat treatment on the structure after the buffer layer is deposited; and a step of forming an electrode on the buffer layer. In this case, the heat treatment is performed after the cladding layer has been planarized, and the heat treatment is also performed after the buffer layer has been deposited. Therefore, even if an oxygen defect occurs on the surface of the optical waveguide layer due to the planarization of the cladding layer and the deposition of the buffer layer, oxygen is supplied to the optical waveguide layer by the heat treatment. Thus, since the oxygen defect is compensated, the propagation loss of the optical waveguide element can be further reduced. Therefore, it is possible to manufacture the optical waveguide element with a further lower propagation loss.

According to each aspect and each embodiment of the present disclosure, an optical waveguide element with a low propagation loss can be manufactured.

### BRIEF DESCRIPTION OF THE DRAWINGS

FIG. 1 is a process diagram showing a method of manufacturing an optical waveguide element according to an embodiment.

FIG. 2A is a view for explaining a step of forming a crystal film.

FIG. 2B is a view for explaining a step of forming an optical waveguide layer.

FIG. 2C is a view for explaining a step of depositing a cladding layer.

FIG. 3 is a process diagram showing a method of manufacturing an optical waveguide element according to another embodiment.

FIG. 4A is a view for explaining a step of depositing a partial portion of a cladding layer.

FIG. 4B is a view for explaining a step of depositing a remaining portion of the cladding layer.

FIG. 5 is a process diagram showing a method of manufacturing an optical waveguide element according to still another embodiment.

FIG. 6A is a view for explaining a step of planarizing a cladding layer.

FIG. 6B is a view for explaining a step of depositing a buffer layer.

FIG. 6C is a view for explaining a step of forming an electrode.

FIG. 7A is a diagram showing the relationship between the annealing time and the insertion loss when the annealing temperature in step S3 shown in FIG. 1 is 400° C.

FIG. 7B is a diagram showing the relationship between the annealing time and the insertion loss when the annealing temperature in step S3 shown in FIG. 1 is 500° C.

FIG. 8 is a diagram showing the propagation loss when the annealing temperature in step S3 shown in FIG. 1 is 500° C.

FIG. 9 is a diagram showing the propagation loss when the annealing temperature in step S3 shown in FIG. 1 is 700° C.

FIG. 10 is a diagram showing an Arrhenius plot.

FIG. 11 is a diagram showing a calculation result of the annealing time.

### DETAILED DESCRIPTION

Hereinafter, embodiments of the present disclosure will be described in detail with reference to the drawings. In the description of the drawings, the same elements are denoted by the same reference numerals, and redundant description will be omitted. In each figure, an XYZ coordinate system may be shown. The Y-axis direction is a direction intersecting (for example, orthogonal to) the X-axis direction and the Z-axis direction. The Z-axis direction is a direction intersecting (for example, orthogonal to) the X-axis direction and the Y-axis direction. In the present specification, the numerical ranges indicated by “to” represent ranges that include the values described before and after “to” as the minimum and maximum values, respectively. The individually described upper and lower limit values can be combined arbitrarily.

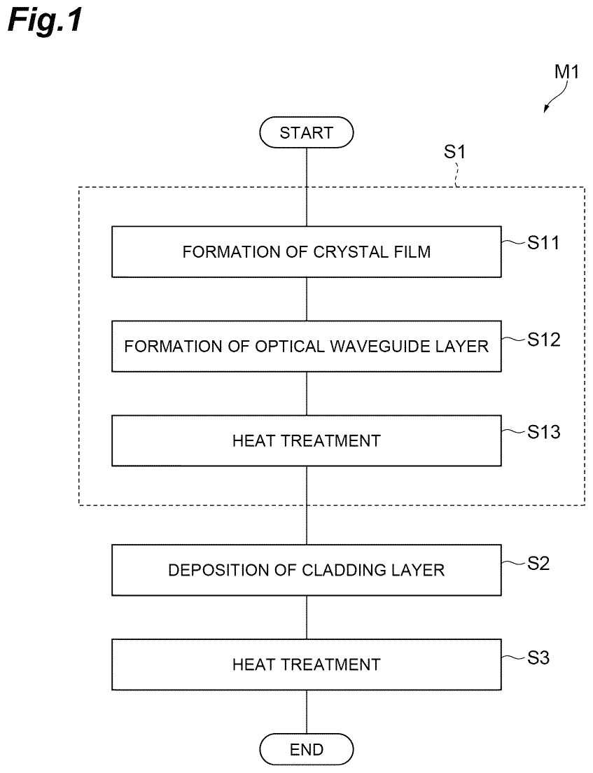

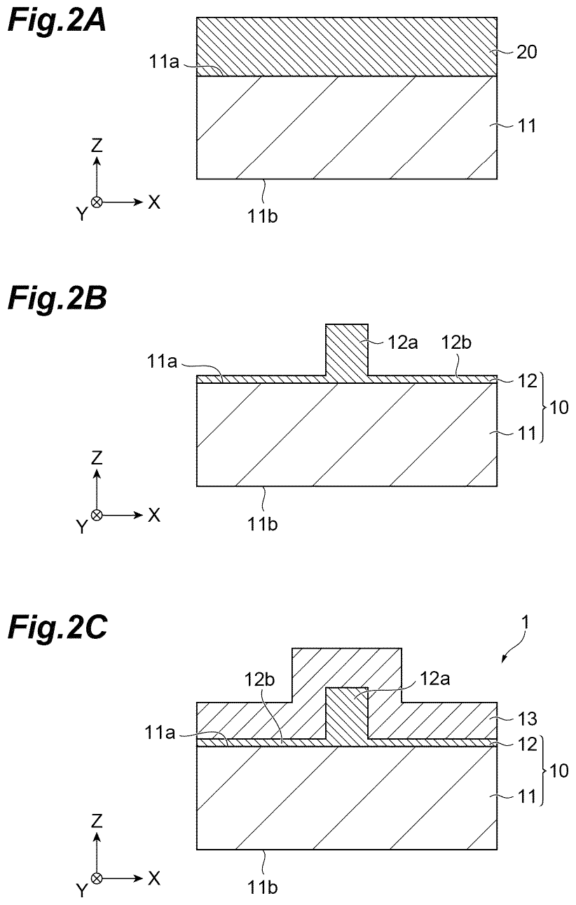

A method of manufacturing an optical waveguide element according to an embodiment will be described with reference to FIGS. 1 and 2A to 2C. FIG. 1 is a process diagram showing a method of manufacturing an optical waveguide element according to an embodiment. FIG. 2A is a view for explaining a step of forming a crystal film. FIG. 2B is a view for explaining a step of forming an optical waveguide layer. FIG. 2C is a view for explaining a step of depositing a cladding layer. A method M1 shown in FIG. 1 is a method of manufacturing an optical waveguide element. The method M1 includes steps S1 to S3.

### <Step S1>

Step S1 is a step of preparing a structure 10. The structure 10 includes a substrate 11 and an optical waveguide layer 12 (see FIG. 2B). The substrate 11 functions as a lower cladding layer. The substrate 11 is made of a material having a refractive index lower than that of the constituent material of the optical waveguide layer 12. Examples of the constituent material of the substrate 11 include sapphire and silicon oxide. Silicon may be used as a constituent material of the substrate 11. In this case, a buffer layer having a refractive index lower than that of the constituent material of the optical waveguide layer 12 is formed on silicon. The substrate 11 has a main surface 11a and a back surface 11b opposite to the main surface 11a. The main surface 11a and the back surface 11b are surfaces defined by the X-axis direction and the Y-axis direction, and intersect with (in the present embodiment, are orthogonal to the Z-axis direction) the Z-axis direction.

The optical waveguide layer 12 is a ridge-type optical waveguide provided on the substrate 11. Specifically, the optical waveguide layer 12 is provided on the main surface 11a of the substrate 11. The optical waveguide layer 12 is made of a crystal material having an electro-optic effect. Examples of the crystal material having the electro-optic effect include lithium niobate (LiNbO₃) and lithium tantalate (LiTaO₃). For example, when the composition of lithium niobate is represented by LiₓNbO_{z}, x may be 0.9 to 1.05 and z may be 2.8 to 3.2. Not more than 10% of each of lithium (Li) and niobium (Nb) may be substituted by another element. Examples of other elements used for substitution include potassium (K), sodium (Na), rubidium (Rb), cesium (Cs), beryllium (Be), magnesium (Mg), calcium (Ca), strontium (Sr), barium (Ba), titanium (Ti), zirconium (Zr), hafnium (Hf), vanadium (V), chromium (Cr), molybdenum (Mo), tungsten (W), iron (Fe), cobalt (Co), nickel (Ni), zinc (Zn), scandium (Sc), and cerium (Ce). Combinations of two or more of these elements may be used for substitution. The same applies to the composition of lithium tantalate. The optical waveguide layer 12 may have a c-axis orientation or an a-axis orientation. In other words, the optical waveguide layer 12 may be made of a Z-cut crystal material or an X-cut crystal material. The optical waveguide layer 12 includes a protruding ridge portion 12a and a plate-like slab 12b.

Step S1 includes steps S11 to S13.

### <Step S11>

Step S11 is a step of forming a crystal film 20, which is a base of the optical waveguide layer 12, on the substrate 11. As shown in FIG. 2A, in step S11, the substrate 11 is first prepared, and the crystal film 20 is formed on the main surface 11a of the substrate 11. The crystal film 20 is made of the above-mentioned crystal material, and is formed by epitaxially growing the crystal material. Examples of the method of forming the crystal film 20 include a sputtering method and a chemical vapor deposition (CVD) method.

### <Step S12>

Following step S11, step S12 is performed. Step S12 is a step of forming the optical waveguide layer 12 by etching the crystal film 20. Specifically, in step S12, first, a mask pattern corresponding to the ridge portion 12a is formed on the crystal film 20. Subsequently, the portion of the crystal film 20 not covered with the mask pattern is etched to a depth corresponding to the height of the ridge portion 12a by dry etching. Thereafter, the mask pattern is removed. Thus, as shown in FIG. 2B, the optical waveguide layer 12 is formed on the main surface 11a of the substrate 11.

### <Step S13>

Following step S12, step S13 is performed. Step S13 is a step of performing a heat treatment (annealing) on the optical waveguide layer 12. The etching in step S12 may cause an oxygen defect in which oxygen drops out from the crystal structure of the crystal material on the surface of the optical waveguide layer 12. Therefore, by performing the heat treatment on the optical waveguide layer 12, oxygen is supplied to the optical waveguide layer 12, and the oxygen defect is compensated.

From the viewpoint of reducing the possibility of cracks occurring in the optical waveguide layer 12, the heat treatment in step S13 is performed at a temperature of 700° C. or less in the atmosphere. From the viewpoint of reducing the time required for the heat treatment, the heat treatment in step S13 is performed at a temperature of 200° C. or more in the atmosphere. When the heat treatment is performed at less than 200° C., the reaction rate is slow, and oxygen is not sufficiently supplied to the optical waveguide layer 12. Hereinafter, the temperature at which the heat treatment is performed may be referred to as “annealing temperature”, and the period during which the heat treatment is performed may be referred to as “annealing time”. Unless otherwise specified, the temperatures are expressed in terms of Celsius temperature (° C.). The annealing time in step S13 is appropriately set in accordance with the annealing temperature. The annealing time for each annealing temperature is obtained in advance by experiment or the like. The higher the annealing temperature, the shorter the annealing time.

The structure 10 is manufactured to be prepared by steps S11 to S13 described above. Between steps S11 and S12, a heat treatment may be performed on the crystal film 20. Step S13 may be omitted. Since oxygen is supplied to the optical waveguide layer 12 by the heat treatment and oxygen defects are compensated, the optical waveguide layer 12 after the heat treatment may differ from the optical waveguide layer 12 before the heat treatment in composition and the like. However, for convenience of description, the same reference numeral is used for the optical waveguide layer 12 before and after the heat treatment. The same applies to the following description.

### <Step S2>

Following step S1, step S2 is performed. Step S2 is a step of depositing all of a cladding layer 13. The cladding layer 13 functions as an upper cladding layer. As shown in FIG. 2C, the cladding layer 13 is formed over the entire upper surface of the optical waveguide layer 12 so as to cover the optical waveguide layer 12. The cladding layer 13 is made of a material having a refractive index lower than that of the constituent material of the optical waveguide layer 12. Examples of the constituent material of the cladding layer 13 include silicon oxides (for example, SiO₂, LaAlSiInO, and SiInO). The film thickness of the cladding layer 13 is substantially uniform over the entire cladding layer 13. The film thickness of the cladding layer 13 is, for example, 0.5 μm to 1.0 μm.

### <Step S3>

Following step S2, step S3 is performed. Step S3 is a step of performing a heat treatment (annealing) on the structure 10 on which the cladding layer 13 has been deposited. The deposition of the cladding layer 13 may cause oxygen defects on the surface of the optical waveguide layer 12. Therefore, by performing the heat treatment on the structure 10 on which the cladding layer 13 has been deposited, oxygen is supplied to the optical waveguide layer 12 through the cladding layer 13, and the oxygen defect is compensated.

From the viewpoint of reducing the possibility of cracks occurring in the optical waveguide layer 12, the heat treatment in step S3 is performed, for example, at a temperature of 700° C. or less in the atmosphere. From the viewpoint of reducing the time required for the heat treatment, the heat treatment in step S3 is performed, for example, at a temperature of 400° C. or more in the atmosphere. In step S3, since the optical waveguide layer 12 is covered with the cladding layer 13, the efficiency of supplying oxygen to the optical waveguide layer 12 is reduced. Therefore, the lower limit value of the annealing temperature in step S3 is higher than the lower limit value of the annealing temperature in step S13. The annealing time in step S3 is appropriately set in accordance with the annealing temperature. The annealing time for each annealing temperature is obtained in advance by experiment or the like. The higher the annealing temperature, the shorter the annealing time.

Thus, the optical waveguide element 1 is manufactured.

In the method M1 described above, the heat treatment is performed after the cladding layer 13 covering the optical waveguide layer 12 is deposited. Therefore, even if an oxygen defect occurs on the surface of the optical waveguide layer 12 when the cladding layer 13 is deposited, oxygen is supplied to the optical waveguide layer 12 through the cladding layer 13 by the heat treatment. As a result, since the oxygen defect is compensated, the propagation loss of the optical waveguide element 1 can be reduced. As described above, the method M1 makes it possible to manufacture the optical waveguide element 1 with a low propagation loss.

The temperature of the heat treatment (annealing temperature) performed on the structure 10 on which the cladding layer 13 is deposited is 400° C. to 700° C. In this case, the time required for the heat treatment can be shortened while reducing the possibility of cracks occurring in the optical waveguide layer 12.

In step S1, the heat treatment is performed after the optical waveguide layer 12 is formed. Therefore, even if an oxygen defect occurs on the surface of the optical waveguide layer 12 by etching, oxygen is supplied to the optical waveguide layer 12 by the heat treatment. As a result, since the oxygen defect is compensated, the propagation loss of the optical waveguide element 1 can be further reduced. Therefore, it is possible to manufacture the optical waveguide element 1 with a further lower propagation loss.

When the crystal material constituting the optical waveguide layer 12 is lithium niobate or lithium tantalate, the optical waveguide layer 12 having an excellent electro-optic effect can be obtained.

When the optical waveguide layer 12 has the c-axis orientation, an electric field is applied to the ridge-shaped ridge portion 12a in the direction (Z-axis direction) in which the optical waveguide layer 12 is laminated on the substrate 11. Therefore, the degree of freedom in designing the optical waveguide layer 12 can be improved, for example, by allowing the ridge portion 12a to be curved. The crystal film 20 having c-axis orientation is formed by forming the crystal film 20 on a substrate 11 made of sapphire by sputtering. Therefore, the manufacture of the optical waveguide element 1 can be simplified.

Silicon oxide has a relatively low refractive index. Therefore, when the cladding layer 13 is made of silicon oxide, the possibility that light is confined in the optical waveguide layer 12 can be increased. As a result, the propagation loss of the optical waveguide element 1 can be further reduced.

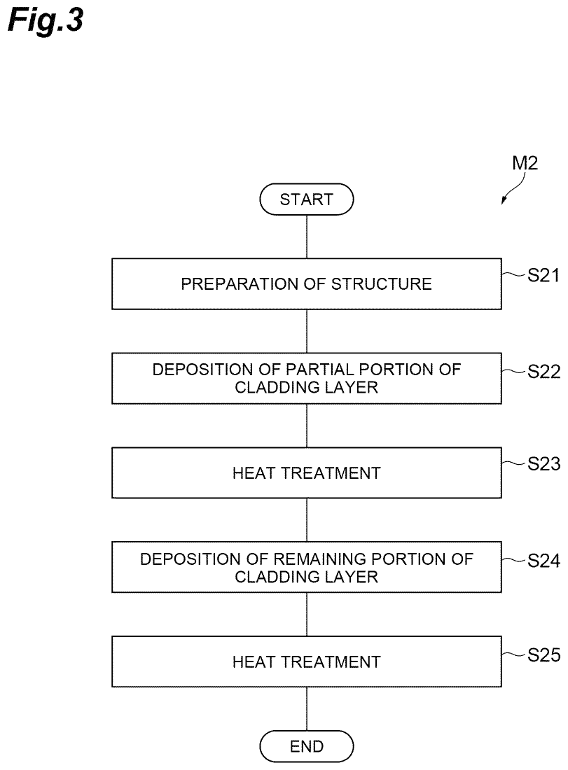

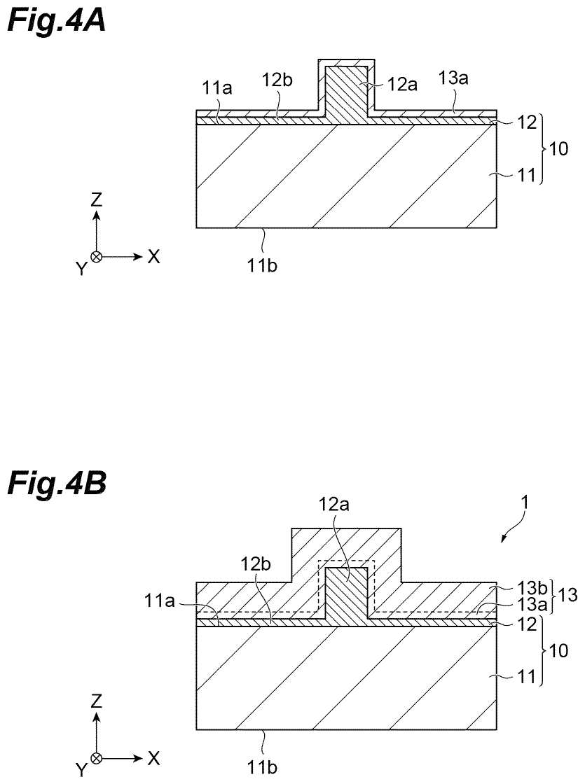

Next, a method of manufacturing an optical waveguide element according to another embodiment will be described with reference to FIGS. 3 and 4A to 4B. FIG. 3 is a process diagram showing a method of manufacturing an optical waveguide element according to another embodiment. FIG. 4A is a view for explaining a step of depositing a partial portion of a cladding layer. FIG. 4B is a view for explaining a step of depositing a remaining portion of the cladding layer. A method M2 shown in FIG. 3 is a method of manufacturing an optical waveguide element, and is mainly different from the method M1 in that the cladding layer 13 is deposited by dividing into a partial portion 13a and a remaining portion 13b. The method M2 includes steps S21 to S25.

### <Step S21>

Step S21 is a step of preparing the structure 10. Since step S21 is the same as step S1, a detailed description thereof will be omitted.

### <Step S22>

Following step S21, step S22 is performed. Step S22 is a step of depositing a partial portion 13a of the cladding layer 13. As shown in FIG. 4A, the partial portion 13a is formed over the entire upper surface of the optical waveguide layer 12 so as to cover the optical waveguide layer 12. The constituent material of the partial portion 13a is the same as that of the cladding layer 13 described above. The film thickness of the partial portion 13a is substantially uniform over the entire partial portion 13a. From the viewpoint of making the film thickness of the partial portion 13a uniform, the film thickness of the partial portion 13a is, for example, 10 nm or more. From the viewpoint of increasing the rate (transmittance) at which oxygen passes through the partial portion 13a, the film thickness of the partial portion 13a is, for example, 100 nm or less. The film thickness of the partial portion 13a is, for example, 1% or more and 20% or less of the film thickness of the cladding layer 13.

### <Step S23>

Following step S22, step S23 is performed. Step S23 is a step of performing a heat treatment (annealing) on the structure 10 in which the partial portion 13a of the cladding layer 13 is deposited. The deposition of the partial portion 13a of the cladding layer 13 may cause oxygen defects on the surface of the optical waveguide layer 12. Therefore, by performing the heat treatment on the structure 10 on which the partial portion 13a has been deposited, oxygen is supplied to the optical waveguide layer 12 through the partial portion 13a, and the oxygen defect is compensated.

From the viewpoint of reducing the possibility of cracks occurring in the optical waveguide layer 12, the heat treatment in step S23 is performed, for example, at a temperature of 700° C. or less in the atmosphere. From the viewpoint of reducing the time required for the heat treatment, the heat treatment in step S23 is performed, for example, at a temperature of 400° C. or more in the atmosphere. The annealing time in step S23 is appropriately set in accordance with the annealing temperature. The annealing time for each annealing temperature is obtained in advance by experiment or the like. The higher the annealing temperature, the shorter the annealing time.

### <Step S24>

Following step S23, step S24 is performed. Step S24 is a step of depositing the remaining portion 13b of the cladding layer 13. As shown in FIG. 4B, the remaining portion 13b is formed over the entire upper surface of the partial portion 13a so as to cover the partial portion 13a after the heat treatment in step S23. The constituent material of the remaining portion 13b is the same as that of the cladding layer 13 described above. The film thickness of the remaining portion 13b is substantially uniform over the entire remaining portion 13b. The film thickness of the remaining portion 13b is larger than the film thickness of the partial portion 13a. The film thickness of the remaining portion 13b is, for example, 0.4 μm to 0.99 μm.

### <Step S25>

Following step S24, step S25 is performed. Step S25 is a step of performing a heat treatment (annealing) on the structure 10 in which the deposition of the cladding layer 13 has been completed by depositing the remaining portion 13b. Since the partial portion 13a is thin, the deposition of the remaining portion 13b may cause oxygen defects on the surface of the optical waveguide layer 12. Therefore, by performing the heat treatment on the structure 10 on which the remaining portion 13b has been deposited, oxygen is supplied to the optical waveguide layer 12 through the cladding layer 13, and the oxygen defect is compensated.

In order to reduce the time required for the heat treatment while reducing the possibility of cracks occurring in the optical waveguide layer 12, the heat treatment in step S25 is performed, for example, at a temperature of 550° C. to 650° C. in the atmosphere. The annealing time in step S25 is appropriately set in accordance with the annealing temperature. The annealing time for each annealing temperature is obtained in advance by experiment or the like. The higher the annealing temperature, the shorter the annealing time. For example, when the annealing temperature is set to 550° C., the annealing time is set to about 7 hours. When the annealing temperature is set to 650° C., the annealing time is set to about 5 hours.

Thus, the optical waveguide element 1 is manufactured. Step S25 may be omitted.

Even in the method M2 described above, the same effects as those of the method M1 can be obtained in the process (configuration) common to the method M1. In the method M2, the cladding layer 13 covering the optical waveguide layer 12 is formed in two stages of the partial portion 13a and the remaining portion 13b, and after the partial portion 13a is deposited, the heat treatment is performed. Therefore, even if oxygen defects occur on the surface of the optical waveguide layer 12 when the partial portion 13a is deposited, oxygen is supplied to the optical waveguide layer 12 through the partial portion 13a by the heat treatment. As a result, since the oxygen defect is compensated, the propagation loss of the optical waveguide element 1 can be reduced. In the method M2, since the heat treatment is performed after the partial portion 13a has been deposited, oxygen is more likely to pass through the partial portion 13a than when the heat treatment is performed after all of the cladding layer 13 has been deposited. That is, since oxygen is efficiently supplied to the optical waveguide layer 12, the time required for the heat treatment can be shortened. As described above, the method M2 makes it possible to manufacture an optical waveguide element with a low propagation loss while improving the manufacturing efficiency.

Since the film thickness of the partial portion 13a is smaller than the film thickness of the remaining portion 13b, oxygen easily passes through the partial portion 13a. In other words, oxygen is supplied to the optical waveguide layer 12 more efficiently. Therefore, the manufacturing efficiency of the optical waveguide element 1 with a low propagation loss can be further improved.

When the film thickness of the partial portion 13a is 10 nm to 100 nm, the partial portion 13a can be deposited with a uniform film thickness, and the rate (transmittance) at which oxygen passes through the partial portion 13a can be increased.

When the temperature of the heat treatment performed on the structure 10 on which the partial portion 13a is deposited is 400° C. to 700° C., the time required for the heat treatment can be shortened while reducing the possibility of cracks occurring in the optical waveguide layer 12.

Oxygen defects may occur on the surface of the optical waveguide layer 12 when the remaining portion 13b is deposited. In the method M2, the heat treatment is performed on the structure 10 in which the deposition of the cladding layer 13 is completed by depositing the remaining portion 13b. Therefore, even if an oxygen defect occurs on the surface of the optical waveguide layer 12 when the remaining portion 13b is deposited, oxygen is supplied to the optical waveguide layer 12 through the cladding layer 13 by the heat treatment. As a result, since the oxygen defect is compensated, the propagation loss of the optical waveguide element 1 can be further reduced. Therefore, it is possible to manufacture the optical waveguide element 1 with a further lower propagation loss.

When the temperature of the heat treatment performed on the structure 10 in which the deposition of the cladding layer 13 has been completed is 550° C. to 650° C., the possibility of cracks occurring in the optical waveguide layer 12 can be reduced, and the time required for the heat treatment can be shortened.

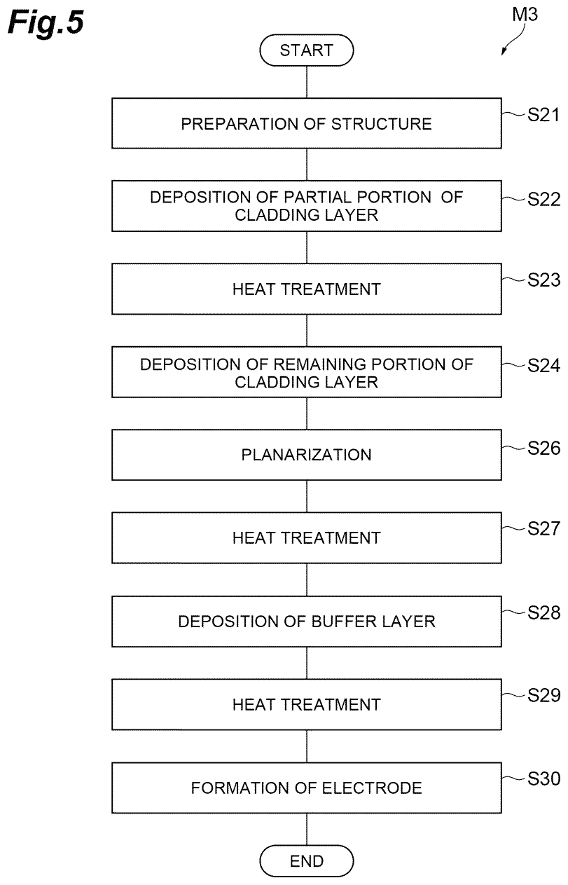

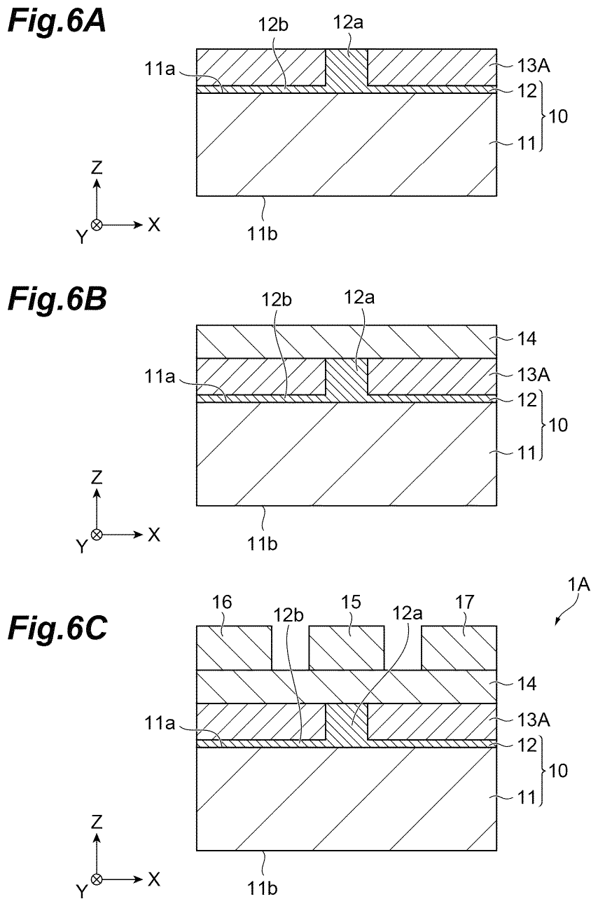

Next, a method of manufacturing an optical waveguide element according to still another embodiment will be described with reference to FIGS. 5 and 6A to 6C. FIG. 5 is a process diagram showing a method of manufacturing an optical waveguide element according to still another embodiment. FIG. 6A is a view for explaining a step of planarizing a cladding layer. FIG. 6B is a view for explaining a step of depositing a buffer layer. FIG. 6C is a view for explaining a step of forming an electrode. A method M3 shown in FIG. 5 is a method of manufacturing an optical waveguide element 1A. The optical waveguide element 1A is an optical modulation element having c-axis orientation. Therefore, the optical waveguide layer 12 has c-axis orientation. The method M3 is mainly different from the method M2 in that the method M3 includes steps S26 to S30 instead of step S25. Here, steps S26 to S30 will be described.

### <Step S26>

Following step S24, step S26 is performed. Step S26 is a step of planarizing the cladding layer 13. As shown in FIG. 6A, the cladding layer 13 is removed by ion milling, chemical mechanical polishing (CMP), or the like until the top surface of the ridge portion 12a is exposed, thereby planarizing the cladding layer 13 (the upper surface of the cladding layer 13). Thus, the cladding layer 13A is obtained.

### <Step S27>

Following step S26, step S27 is performed. Step S27 is a step of performing a heat treatment (annealing) on the structure 10 after the cladding layer 13 is planarized. The deposition of the remaining portion 13b and the planarization of the cladding layer 13 may cause oxygen defects on the surface of the optical waveguide layer 12. Therefore, oxygen is supplied to the optical waveguide layer 12 by applying the heat treatment to the structure 10.

From the viewpoint of reducing the possibility of cracks occurring in the optical waveguide layer 12, the heat treatment in step S27 is performed, for example, at a temperature of 700° C. or less in the atmosphere. From the viewpoint of reducing the time required for the heat treatment, the heat treatment in step S27 is performed, for example, at a temperature of 400° C. or more in the atmosphere. The annealing time in step S27 is appropriately set in accordance with the annealing temperature. The annealing time for each annealing temperature is obtained in advance by experiment or the like. The higher the annealing temperature, the shorter the annealing time.

### <Step S28>

Following step S27, step S28 is performed. Step S28 is a step of depositing the buffer layer 14 on the cladding layer 13A. The buffer layer 14 is provided to prevent light from being absorbed by the electrodes 15 to 17 to be described later. As shown in FIG. 6B, the buffer layer 14 is formed over the entire upper surface of the cladding layer 13A and the entire top surface of the ridge portion 12a so as to cover the cladding layer 13A and the ridge portion 12a. The buffer layer 14 is made of a material having a refractive index lower than that of the constituent material of the optical waveguide layer 12. Examples of the constituent material of the buffer layer 14 include silicon oxides (for example, SiO₂, LaAlSiInO, and SiInO). The film thickness of the buffer layer 14 is substantially uniform over the entire buffer layer 14. The film thickness of the buffer layer 14 is, for example, 0.4 μm to 1.0 μm.

### <Step S29>

Following step S28, step S29 is performed. Step S29 is a step of performing a heat treatment (annealing) on the structure 10 after the buffer layer 14 is deposited. The deposition of the buffer layer 14 may cause oxygen defects on the surface of the optical waveguide layer 12. Therefore, oxygen is supplied to the optical waveguide layer 12 through the buffer layer 14 and the cladding layer 13A by applying the heat treatment to the structure 10.

From the viewpoint of reducing the possibility of cracks occurring in the optical waveguide layer 12, the heat treatment in step S29 is performed, for example, at a temperature of 700° C. or less in the atmosphere. From the viewpoint of reducing the time required for the heat treatment, the heat treatment in step S29 is performed, for example, at a temperature of 400° C. or more in the atmosphere. The annealing time in step S29 is appropriately set in accordance with the annealing temperature. The annealing time for each annealing temperature is obtained in advance by experiment or the like. The higher the annealing temperature, the shorter the annealing time.

### <Step S30>

Following step S29, step S30 is performed. Step S30 is a step of forming the electrodes 15 to 17 on the buffer layer 14. The electrode 15 is a signal electrode. The electrode 15 is formed on the ridge portion 12a via the buffer layer 14. The electrode 15 extends along the ridge portion 12a. The electrodes 16 and 17 are ground electrodes. The electrodes 16 and 17 are formed on the buffer layer 14 so as to be spaced apart from the electrode 15, with the electrode 15 positioned between the electrodes 16 and 17. The electrodes 15 to 17 are made of a metal material.

Thus, the optical waveguide element 1A is manufactured. The method M3 may include steps S1 to S3 of the method M1 instead of steps S21 to S24.

Even in the method M3 described above, the same effects as those of the method M2 can be obtained in the process (configuration) common to the method M2. In the method M3, the heat treatment is performed after the cladding layer 13 has been planarized, and the heat treatment is also performed after the buffer layer 14 is deposited. Therefore, even if an oxygen defect occurs on the surface of the optical waveguide layer 12 due to the deposition of the remaining portion 13b, the planarization of the cladding layer 13, and the deposition of the buffer layer 14, oxygen is supplied to the optical waveguide layer 12 by the heat treatment. Thus, since the oxygen defect is compensated, the propagation loss of the optical waveguide element 1A can be reduced. Therefore, it is possible to manufacture the optical waveguide element 1A with a low propagation loss.

The method of manufacturing an optical waveguide element according to the present disclosure is not limited to the above embodiments.

For example, the annealing temperature in step S13 may be appropriately changed according to the structure and the constituent material of the optical waveguide layer 12, and may be lower than 200° C. or higher than 700° C. The annealing temperature in step S3 may be appropriately changed according to the structure and the constituent material of the optical waveguide layer 12 and the structure and the constituent material of the cladding layer 13, and may be lower than 400° C. or higher than 700° C.

The annealing temperature in step S23 may be appropriately changed according to the structure and the constituent material of the optical waveguide layer 12 and the structure (film thickness) and the constituent material of the partial portion 13a of the cladding layer 13, and may be lower than 400° C. or higher than 700° C. The annealing temperature in step S25 may be appropriately changed according to the structure and the constituent material of the optical waveguide layer 12 and the structure and the constituent material of the cladding layer 13, and may be lower than 550° C. or higher than 650° C.

The annealing temperature in step S27 may be appropriately changed according to the structure and the constituent material of the optical waveguide layer 12 and the structure and the constituent material of the cladding layer 13A, and may be lower than 400° C. or higher than 700° C. The annealing temperature in step S29 may be appropriately changed according to the structure and the constituent material of the optical waveguide layer 12, the structure and the constituent material of the cladding layer 13, and the structure (film thickness) and the constituent material of the buffer layer 14, and may be lower than 400° C. or higher than 700° C.

Hereinafter, the present disclosure will be described in more detail with reference to Examples in order to describe the above effects. The present disclosure is not limited to these examples.

### <Evaluation of Insertion Loss>

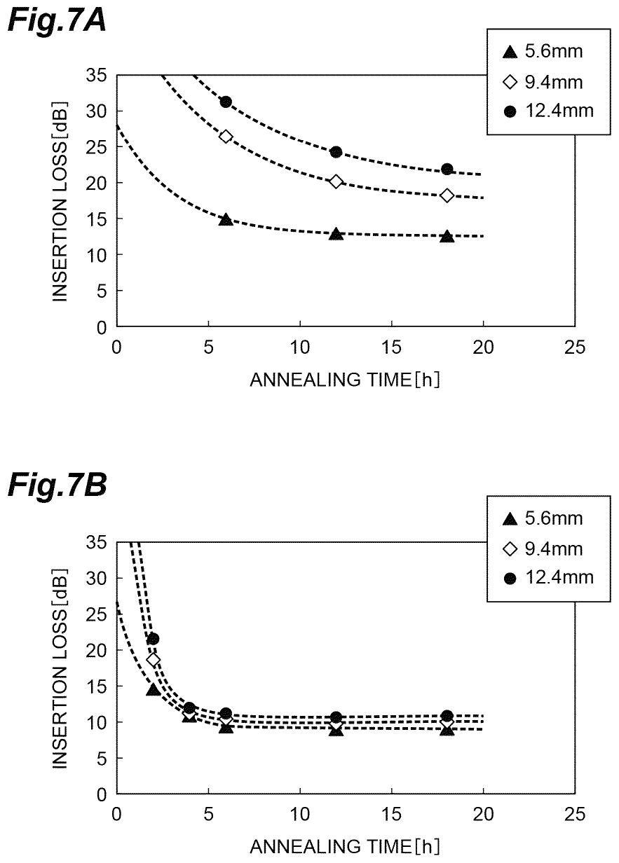

The evaluation of the insertion loss will be described with reference to FIGS. 7A and 7B. FIG. 7A is a diagram showing the relationship between the annealing time and the insertion loss when the annealing temperature in step S3 shown in FIG. 1 is 400° C. FIG. 7B is a diagram showing the relationship between the annealing time and the insertion loss when the annealing temperature in step S3 shown in FIG. 1 is 500° C. The horizontal axis of FIGS. 7A and 7B represents annealing time (unit: time). The vertical axis of FIGS. 7A and 7B represents the insertion loss (unit: dB).

The evaluation of the insertion loss was conducted using three optical waveguide elements manufactured by the method M1 shown in FIG. 1, having waveguide lengths of 5.6 mm, 9.4 mm, and 12.4 mm, respectively. These three optical waveguide elements had a waveguide width of 0.7 μm and a waveguide height of 0.7 μm. The waveguide length is the length of the ridge portion 12a in the Y-axis direction. The waveguide width is the length of the ridge portion 12a in the X-axis direction, and may be referred to as “waveguide width W” hereinafter. The waveguide height is the length of the ridge portion 12a in the Z-axis direction. In these three optical waveguide elements, sapphire was used as a constituent material of the substrate 11, lithium niobate (LiNbO₃) was used as a constituent material of the optical waveguide layer 12, and silicon dioxide (SiO₂) was used as a constituent material of the cladding layer 13. Insertion loss was measured by light having a wavelength of 637 nm being incident on each optical waveguide elements obtained by performing a heat treatment (annealing) for 6 hours, 12 hours, and 18 hours at annealing temperatures of 400° C. and 500° C.

As shown in FIGS. 7A and 7B, it can be seen that, at any annealing temperature, the insertion loss increases as the waveguide length increases for the same annealing time. It can be seen that, at any annealing temperature, for the same waveguide length, the insertion loss decreases as the annealing time increases, but the amount of decrease (rate of decrease) in the insertion loss per unit time decreases.

### <Evaluation of Propagation Loss>

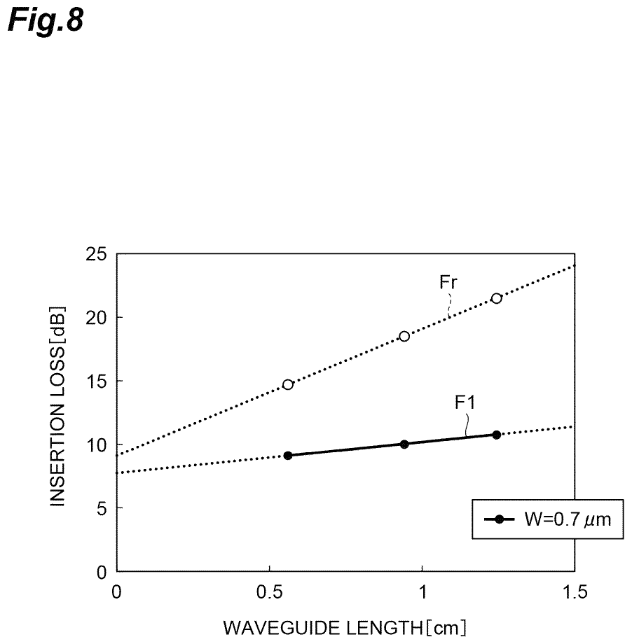

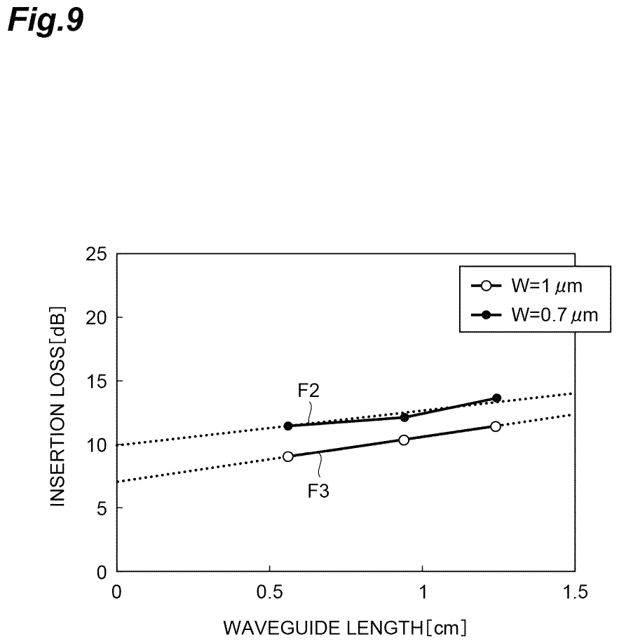

The evaluation of the propagation loss will be described with reference to FIGS. 8 and 9. FIG. 8 is a diagram showing the propagation loss when the annealing temperature in step S3 shown in FIG. 1 is 500° C. FIG. 9 is a diagram showing the propagation loss when the annealing temperature in step S3 shown in FIG. 1 is 700° C. The horizontal axis of FIGS. 8 and 9 represents the waveguide length (unit: cm). The vertical axis of FIGS. 8 and 9 represents the insertion loss (unit: dB).

The propagation loss is obtained as the slope of a linear function when the insertion loss is approximated by a linear function of the waveguide length. The function Fr shown in FIG. 8 is a function obtained by approximating, with a linear function of the waveguide length, the insertion loss measured when light having a wavelength of 637 nm is incident on the three optical waveguide elements used in the evaluation of the insertion loss of FIG. 7B, which are the three optical waveguide elements at the time of performing the heat treatment at an annealing temperature of 500° C. for 2 hours. The function Fr is expressed by y=9.95x+9.16 where x is the waveguide length and y is the insertion loss. Therefore, the propagation loss at the time when the heat treatment at an annealing temperature of 500° C. for 2 hours was performed is about 10 dB/cm. Since none of the optical waveguide elements propagated light before the heat treatment in step S3 was performed, the propagation loss at the time when the heat treatment was performed at an annealing temperature of 500° C. for 2 hours is used as an object of comparison.

The function F1 shown in FIG. 8 is a function obtained by approximating the insertion loss measured when light having a wavelength of 637 nm is incident on the three optical waveguide elements obtained by additionally performing a heat treatment at an annealing temperature of 500° C. for 16 hours on the three optical waveguide elements (that is, at the time when the heat treatment is performed for 18 hours) with a linear function of the waveguide length. The function F1 is expressed by y=2.43x+7.75 where x is the waveguide length and y is the insertion loss. Therefore, the propagation loss after the heat treatment was performed is about 2.4 dB/cm. From the above, it can be seen that the propagation loss is reduced by the heat treatment in step S3.

The function F2 shown in FIG. 9 is a function obtained by approximating the insertion loss measured when light having a wavelength of 637 nm is incident on three optical waveguide elements obtained by a heat treatment at an annealing temperature of 700° C. for 6 hours with a linear function of the waveguide length. The three optical waveguide elements used to obtain the function F2 were different from the three optical waveguide elements used for the evaluation in FIG. 8 only in the annealing temperature and the annealing time in step S3, and the constituent materials and structures of the respective layers were the same. The function F2 is expressed by y=2.82x+9.86 where x is the waveguide length and y is the insertion loss. Therefore, the propagation loss after the heat treatment was performed is about 2.8 dB/cm. Since this propagation loss is almost the same as the propagation loss at the time of performing the heat treatment at the annealing temperature of 500° C. for 18 hours, it can be seen that the propagation loss is reduced by the heat treatment in step S3.

The function F3 shown in FIG. 9 is a function obtained by approximating the insertion loss measured when light having a wavelength of 637 nm is incident on three optical waveguide elements obtained by performing the heat treatment on three optical waveguide elements having only a waveguide width W different from the three optical waveguide elements used to obtain the function F2 at an annealing temperature of 700° C. for 6 hours with a linear function of the waveguide length. The waveguide width W of these three optical waveguide elements was 1 μm. The function F3 is expressed by y=3.53x+7.03 where x is the waveguide length and y is the insertion loss. Therefore, the propagation loss after the heat treatment was performed is about 3.5 dB/cm. Since the propagation loss is almost the same as in the case where the waveguide width W is 0.7 μm, it is considered that the propagation loss is reduced by the heat treatment in step S3.

### <Calculation Method of Annealing Time>

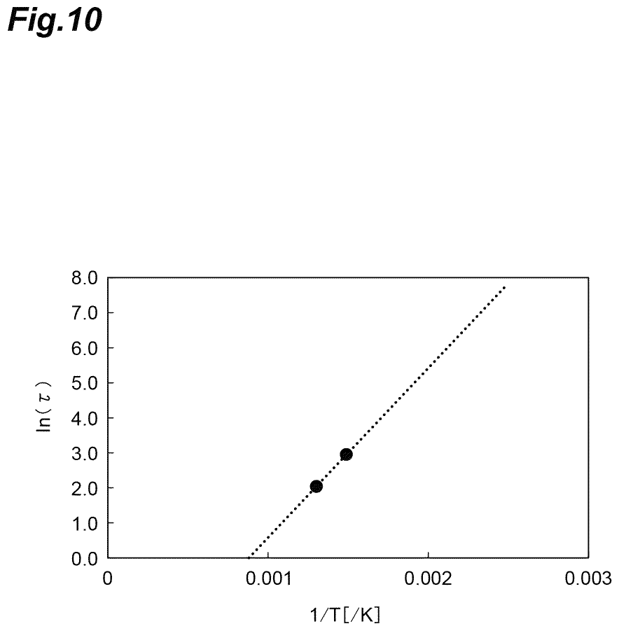

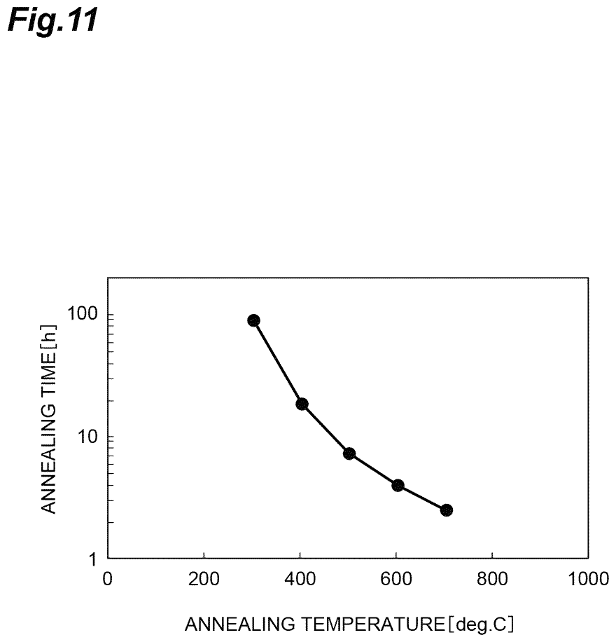

An example of a method of calculating the annealing time will be described with reference to FIGS. 7A, 7B, 10, and 11. FIG. 10 is a diagram showing an Arrhenius plot. FIG. 11 is a diagram showing a calculation result of the annealing time. The horizontal axis of FIG. 10 represents the reciprocal of the absolute temperature T (unit: K⁻¹). The vertical axis of FIG. 10 represents the natural logarithm of time t. The horizontal axis of FIG. 11 represents the annealing temperature (unit: deg. C). The vertical axis of FIG. 11 represents the annealing time (unit: time).

As shown in FIGS. 7A and 7B, the insertion loss IL monotonously decreases in an exponential manner with the annealing time t. Therefore, the insertion loss IL can be expressed by Equation (1) using the optical loss A in the initial state, the time constant B, the optical loss C which is not affected by annealing, and the annealing time t. By the least-squares fitting, each insertion loss shown in FIGS. 7A and 7B is expressed by Equation (1), and the time τ is obtained. The time t is an annealing time t at which the amount of decrease (rate of decrease) in the insertion loss IL per hour falls below 0.1 dB.

$$\begin{matrix}[ Equation 1 ] & \\ IL = A exp ( Bt ) + C & ( 1 )\end{matrix}$$

The time τ when the annealing temperature is 400° C. and the time τ when the annealing temperature is 500° C. are obtained and used to create the Arrhenius plot shown in FIG. 10. Here, the average of the times τ obtained for the three kinds of waveguide lengths shown in FIG. 7A is used as the time τ when the annealing temperature is 400° C. Similarly, the average of the times τ obtained for the three kinds of waveguide lengths shown in FIG. 7B is used as the time τ when the annealing temperature is 500° C.

The graph of the Arrhenius plot shown in FIG. 10 is expressed by Equation (2) using the activation energy Ea, the Boltzmann constant k, and the absolute temperature T. Therefore, the activation energy Ea is obtained by multiplying the slope of the graph by the Boltzmann constant k. Here, the graph shown in FIG. 10 is expressed by y=4863.9x−4.3, where x is the reciprocal of the absolute temperature and y is the natural logarithm of time τ. Therefore, the activation energy Ea is 0.42 eV (9.66 kcal/mol).

$$\begin{matrix}[ Equation 2 ] & \\ ln τ = ln A + \frac{Ea}{kT} & ( 2 )\end{matrix}$$

As shown in FIG. 11, the time τ at an arbitrary absolute temperature T can be obtained by substituting the activation energy Ea into Equation (2). The time τ obtained at each absolute temperature T can be used as the annealing time when the absolute temperature Tis set as the annealing temperature. According to FIG. 11, when the annealing temperature is 400° C., the annealing time is about 20 hours, but when the annealing temperature is 300° C., the annealing time is about 100 hours. It is found that the annealing time increases sharply when the annealing temperature is lower than 400° C.

### Additional Statements

### [Clause 1]

A method of manufacturing an optical waveguide element, comprising:
a step of preparing a structure including a substrate and a ridge-shaped optical waveguide layer provided on the substrate and made of a crystal material having an electro-optic effect;
a step of depositing all of a cladding layer covering the optical waveguide layer; and
a step of performing a heat treatment on the structure on which the cladding layer has been deposited.

### [Clause 2]

The method of manufacturing an optical waveguide element according to clause 1, wherein a temperature of the heat treatment is 400° C. or more and 700° C. or less.

### [Clause 3]

A method of manufacturing an optical waveguide element, comprising:
a step of preparing a structure including a substrate and a ridge-shaped optical waveguide layer provided on the substrate and made of a crystal material having an electro-optic effect;
a step of depositing a partial portion of a cladding layer covering the optical waveguide layer;
a step of performing a heat treatment on the structure on which the partial portion of the cladding layer is deposited; and
a step of depositing a remaining portion of the cladding layer so as to cover the partial portion of the cladding layer after the heat treatment.

### [Clause 4]

The method of manufacturing an optical waveguide element according to clause 3, wherein a film thickness of the partial portion of the cladding layer is smaller than a film thickness of the remaining portion of the cladding layer.

### [Clause 5]

The method of manufacturing an optical waveguide element according to clause 3 or 4, wherein a film thickness of the partial portion of the cladding layer is 10 nm or more and 100 nm or less.

### [Clause 6]

The method of manufacturing an optical waveguide element according to any one of clauses 3 to 5, wherein a temperature of the heat treatment performed on the structure on which the partial portion of the cladding layer is deposited is 400° C. or more and 700° C. or less.

### [Clause 7]

The method of manufacturing an optical waveguide element according to any one of clauses 3 to 6, further comprising a step of performing a heat treatment on the structure on which the cladding layer has been deposited by depositing the remaining portion of the cladding layer.

### [Clause 8]

The method of manufacturing an optical waveguide element according to clause 7, wherein a temperature of the heat treatment performed on the structure on which the cladding layer has been deposited is 550° C. or more and 650° C. or less.

### [Clause 9]

The method of manufacturing an optical waveguide element according to any one of clauses 1 to 8, wherein the step of preparing the structure comprises:
a step of forming a crystal film made of the crystal material on the substrate;
a step of forming the optical waveguide layer by etching the crystal film; and
a step of performing a heat treatment on the optical waveguide layer.

### [Clause 10]

The method of manufacturing an optical waveguide element according to any one of clauses 1 to 9, wherein the crystal material is lithium niobate or lithium tantalate.

### [Clause 11]

The method of manufacturing an optical waveguide element according to any one of clauses 1 to 10, wherein the optical waveguide layer has c-axis orientation.

### [Clause 12]

The method of manufacturing an optical waveguide element according to any one of clauses 1 to 11, wherein the cladding layer is made of silicon oxide.

### [Clause 13]

The method of manufacturing an optical waveguide element according to any one of clauses 1 to 12, further comprising:
a step of planarizing the cladding layer;
a step of performing a heat treatment on the structure after the cladding layer is planarized;
a step of depositing a buffer layer on the planarized cladding layer;
a step of performing a heat treatment on the structure after the buffer layer is deposited; and
a step of forming an electrode on the buffer layer.

What is claimed is:

1. A method of manufacturing an optical waveguide element, comprising:
a step of preparing a structure including a substrate and a ridge-shaped optical waveguide layer provided on the substrate and made of a crystal material having an electro-optic effect;
a step of depositing all of a cladding layer covering the optical waveguide layer; and
a step of performing a heat treatment on the structure on which the cladding layer has been deposited.

2. The method of manufacturing an optical waveguide element according to claim 1, wherein a temperature of the heat treatment is 400° C. or more and 700° C. or less.

3. A method of manufacturing an optical waveguide element, comprising:
a step of preparing a structure including a substrate and a ridge-shaped optical waveguide layer provided on the substrate and made of a crystal material having an electro-optic effect;
a step of depositing a partial portion of a cladding layer covering the optical waveguide layer;
a step of performing a heat treatment on the structure on which the partial portion of the cladding layer is deposited; and
a step of depositing a remaining portion of the cladding layer so as to cover the partial portion of the cladding layer after the heat treatment.

4. The method of manufacturing an optical waveguide element according to claim 3, wherein a film thickness of the partial portion of the cladding layer is smaller than a film thickness of the remaining portion of the cladding layer.

5. The method of manufacturing an optical waveguide element according to claim 3, wherein a film thickness of the partial portion of the cladding layer is 10 nm or more and 100 nm or less.

6. The method of manufacturing an optical waveguide element according to claim 3, wherein a temperature of the heat treatment performed on the structure on which the partial portion of the cladding layer is deposited is 400° C. or more and 700° C. or less.

7. The method of manufacturing an optical waveguide element according to claim 3, further comprising a step of performing a heat treatment on the structure on which the cladding layer has been deposited by depositing the remaining portion of the cladding layer.

8. The method of manufacturing an optical waveguide element according to claim 7, wherein a temperature of the heat treatment performed on the structure on which the cladding layer has been deposited is 550° C. or more and 650° C. or less.

9. The method of manufacturing an optical waveguide element according to claim 1, wherein the step of preparing the structure comprises:
a step of forming a crystal film made of the crystal material on the substrate;
a step of forming the optical waveguide layer by etching the crystal film; and
a step of performing a heat treatment on the optical waveguide layer.

10. The method of manufacturing an optical waveguide element according to claim 1, wherein the crystal material is lithium niobate or lithium tantalate.

11. The method of manufacturing an optical waveguide element according to claim 1, wherein the optical waveguide layer has c-axis orientation.

12. The method of manufacturing an optical waveguide element according to claim 1, wherein the cladding layer is made of silicon oxide.

13. The method of manufacturing an optical waveguide element according to claim 1, further comprising:
a step of planarizing the cladding layer;
a step of performing a heat treatment on the structure after the cladding layer is planarized;
a step of depositing a buffer layer on the planarized cladding layer;
a step of performing a heat treatment on the structure after the buffer layer is deposited; and
a step of forming an electrode on the buffer layer.
